(19) United States
(12) Patent Application Publication
(10) Pub. No.: US 2025/0296439 A1
(43) Pub. Date: Sep. 25, 2025

(54) CABIN ENVIRONMENT CONTROL APPARATUS

(71) Applicant: Honda Motor Co., Ltd., Tokyo (JP)

(72) Inventors: Sunao Yamaguchi, Tokyo (JP); Kaede Inoguchi, Tokyo (JP); Kaho Tonomura, Tokyo (JP)

(21) Appl. No.: 19/060,716

(22) Filed: Feb. 23, 2025

(30) Foreign Application Priority Data
Mar. 21, 2024 (JP) 2024-045221

(51) Int. Cl. B60K 35/26; B60K 35/28; B60K 35/80

(52) U.S. Cl. CPC B60K 35/26; B60K 35/28; B60K 35/80

(57) ABSTRACT

A cabin environment control apparatus includes a microprocessor connected to a sound output device provided in a cabin of a vehicle. The microprocessor is configured to perform: calculating a degree of fatigue of an occupant of the vehicle based on biological information of the occupant; generate a signal for reproducing sound content to the sound output device; and controlling the sound output device to add a reverberation effect to the sound content and reproduce the sound content when the degree of fatigue of the occupant is equal to or higher than a predetermined value.

### CROSS-REFERENCE TO RELATED APPLICATION

This application is based upon and claims the benefit of priority from Japanese Patent Application No. 2024-045221 filed on Mar. 21, 2024, the content of which is incorporated herein by reference.

### BACKGROUND

### Technical Field

The present invention relates to a cabin environment control apparatus configured to control an environment in a cabin of a vehicle.

### Related Art

As such a type of technology, a technology for reducing physical or mental fatigue not only for a driver of a vehicle but also for an occupant who rides together has been developed. For example, JP 2013-518632 T discloses a fatigue recovery method of controlling a massage device incorporated in a seat backrest to transmit an instruction to an occupant and physically and mentally revitalize the occupant.

However, the technology according to the related art is less effective for an occupant who feels uncomfortable about physical stimulation or an occupant who wants to mainly reduce mental fatigue.

### SUMMARY

An aspect of the present invention is a cabin environment control apparatus including a microprocessor connected to a sound output device provide in a cabin of a vehicle. The microprocessor is configured to perform: calculating a degree of fatigue of an occupant of the vehicle based on biological information of the occupant; generating a signal for reproducing sound content to the sound output device; and controlling the sound output device to add a reverberation effect to the sound content and reproduce the sound content when the degree of fatigue of the occupant is equal to or higher than a predetermined value.

### BRIEF DESCRIPTION OF DRAWINGS

The objects, features, and advantages of the present invention will become clearer from the following description of embodiments in relation to the attached drawings, in which:

FIG. 1 is a schematic diagram illustrating an example of an IVI system including a cabin environment control apparatus;

FIG. 2 is a diagram illustrating an operation menu screen;

FIG. 3A is a block diagram illustrating a configuration of a main part of the cabin environment control apparatus;

FIG. 3B is a block diagram illustrating a configuration of a main part of a terminal;

FIG. 3C is a block diagram illustrating a configuration of a main part of a vehicle sensor group and a vehicle cabin camera;

FIG. 3D is a block diagram illustrating a configuration of a main part of an input device and an output device; and

FIG. 4 is a flowchart for describing an example of cabin environment control processing by a program.

### DETAILED DESCRIPTION OF THE INVENTION

An embodiment of the invention will be described below with reference to the drawings.

### <Outline of Cabin Environment Control Apparatus>

A cabin environment control apparatus according to the embodiment controls a cabin environment so as to reduce mental fatigue of a person in a cabin of a moving vehicle such as an automobile. In the embodiment, as an example, a reverberation effect is added to a sound content reproduced in the cabin. The sound content includes a voice content and a music content.

In general, a space of the cabin is narrower than a space in which acoustically sufficient reverberation can be achieved, and reflection of sound is suppressed due to a ceiling, a wall, and a floor of the cabin formed using a sound absorbing material or the like. Therefore, it is usually difficult to feel reverberation of sound in the cabin. Therefore, in the embodiment, a reproduction device simulatively generates and reproduces echo generated by repeated reflection of sound between a ceiling, a wall, and a floor of a space wider than the cabin. In other words, the reproduction device that reproduces the sound content adds the reverberation effect to the content and reproduces the content.

The cabin environment control apparatus provides a service that soothes an occupant and reduces mental fatigue by the added reverberation effect in the cabin.

In the embodiment, the cabin environment control apparatus is provided as one of functions of an in-vehicle infotainment (IVI) system provided in a vehicle. Such a cabin environment control apparatus will be described in more detail.

### System Configuration Example

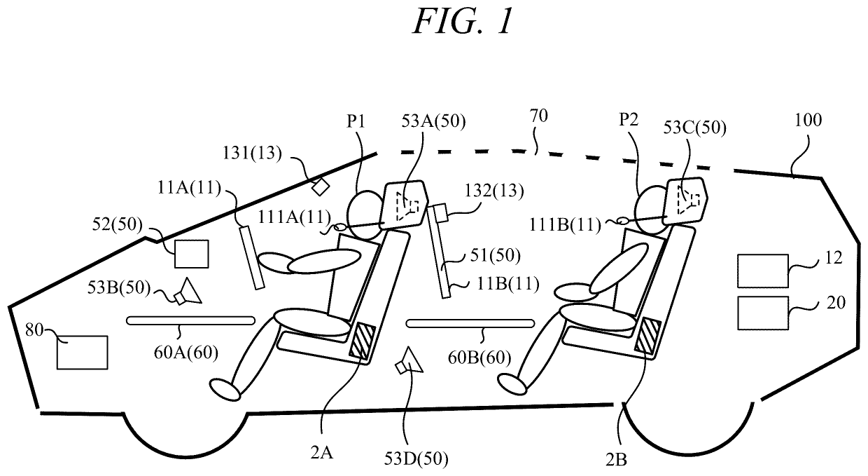

FIG. 1 is a schematic diagram illustrating an example of the IVI system including the cabin environment control apparatus. The IVI system includes a control apparatus 20, a vehicle sensor group 12 of a vehicle 100 serving as a moving body, a display unit 51, a projection unit 52, and voice reproducing units 53A to 53D included in an output device 50 provided in the vehicle 100, operation detection units 11A and 11B and microphones 111A and 111B included in an input device 11 provided in the vehicle 100, a front seat camera 131 and a rear seat camera 132 included in a vehicle cabin camera 13 provided in the vehicle 100, a terminal 2A used by an occupant P1 in a front seat of a cabin, and a terminal 2B used by an occupant P2 in a rear seat of the cabin.

The control apparatus 20 and the terminals 2A and 2B are configured to be capable of wireless communication. The control apparatus 20, the output device 50, the input device 11, the vehicle sensor group 12, and the vehicle cabin camera 13 are configured to be capable of wired communication using a controller area network (CAN) or the like.

The vehicle 100 includes an air-conditioning device 80 that adjusts temperature and humidity in the cabin, a lighting device 70 (which may also be referred to as a dimmable sunroof) that can adjust a lighting amount for the inside of the cabin by using dimmable glass covering substantially the entire ceiling of the cabin, and an ambient light 60A for the front seat and an ambient light 60B for the rear seat included in an illumination device 60.

As an example, the terminals 2A and 2B are implemented by smartphones or the like used by the occupants P1 and P2, respectively. Each of the terminals 2A and 2B may be held by a holder (not illustrated) installed on a seat on which each person is seated.

Although the two terminals 2A and 2B are illustrated as terminals used by the occupants P1 and P2, the actual number of terminals varies depending on the number of occupants. The number of terminals is four in a case where there are four occupants. In addition, the number of cameras in the vehicle cabin camera 13, the number of operation detection units and the number of microphones in the input device 11, and the number of display units, the number of projection units, and the number of voice reproducing units in the output device 50 may also appropriately vary depending on the number of occupants.

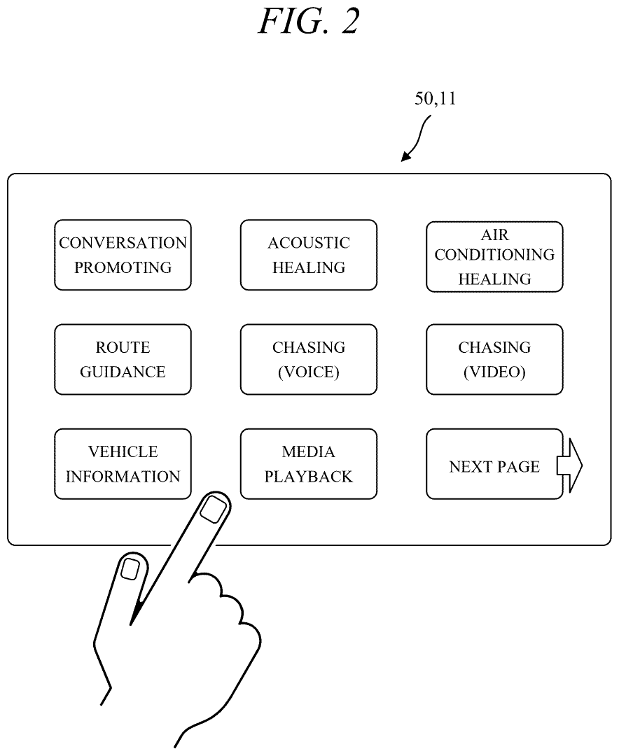

FIG. 2 is a diagram illustrating an operation menu screen of the IVI system of FIG. 1. In the embodiment, the operation menu screen is projected or displayed on the output device 50 (the projection unit 52 or the display unit 51). When a menu button (which may be referred to as an icon) displayed on the output device 50 is touched or a voice corresponding to the menu button is input from the microphones 111A and 111B included in the input device 11, the control apparatus 20 starts an operation of a function corresponding to the menu for which the touch operation has been made or the voice has been input.

The operation menu screen illustrated in FIG. 2 includes menu buttons corresponding to a “conversation promoting” function of supporting a conversation between the occupants of the vehicle 100, a “acoustic healing” function of soothing the occupants by reproduced sounds of the voice reproducing units 53A to 53D, an “air conditioning healing” function of soothing the occupants by using the air-conditioning device 80, a “route guidance” function of guiding a traveling route to a destination, a “chasing (voice)” function of connecting the terminal of the occupant who gets off the vehicle 100 and a communication unit (described below) of the control apparatus 20 to transmit an external voice to the occupant in the cabin, a “chasing (video)” function of connecting the terminal of the occupant who gets off the vehicle 100 and the communication unit (described below) of the control apparatus 20 to transmit an external video to the occupant in the cabin, a “vehicle information” function of performing function setting of the vehicle 100, an auxiliary machine operation, and the like, a “media playback” function of reproducing a medium in which a content is recorded from the output device 50, and other functions (not described).

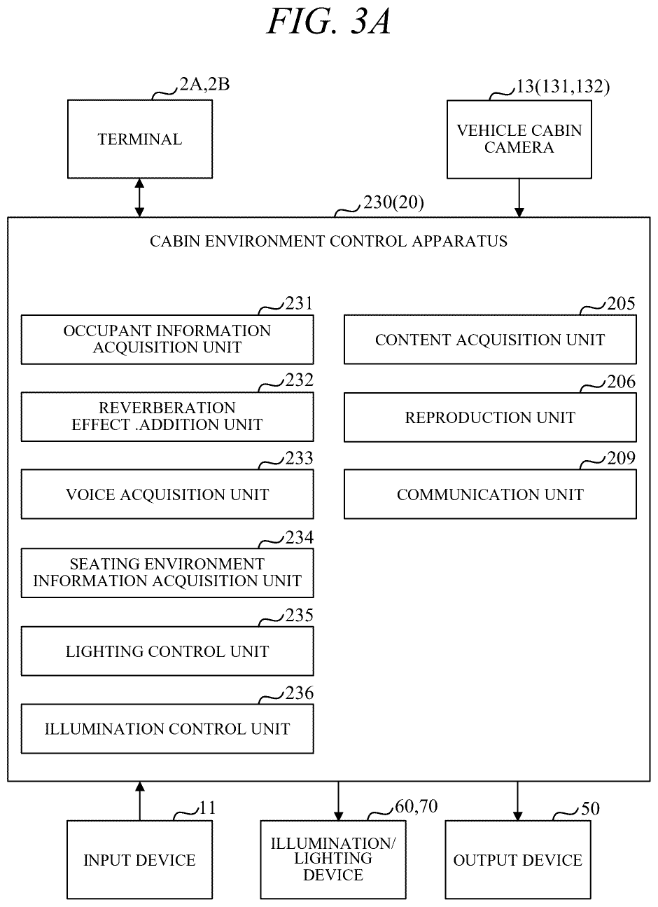

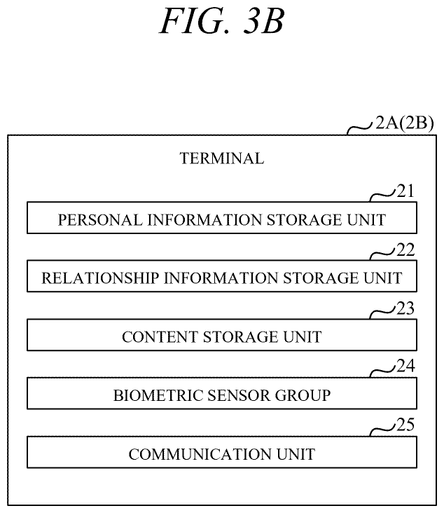

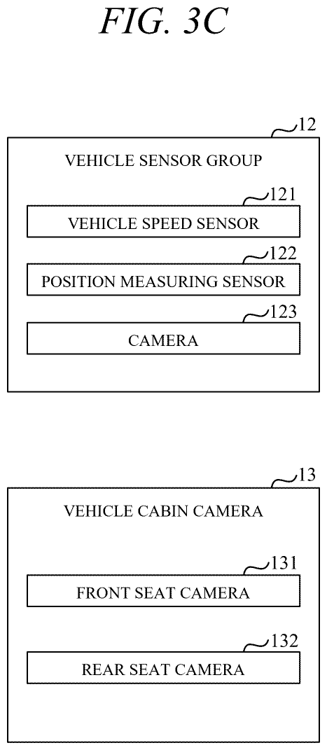

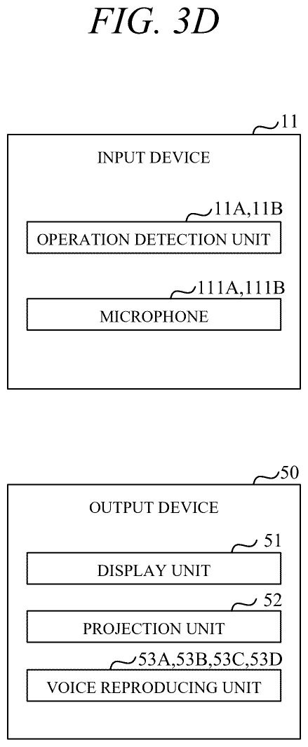

Hereinafter, a function of the control apparatus 20 as the cabin environment control apparatus in a case where the “soothing sounds” button on the operation menu screen is operated will be mainly described. FIGS. 3A to 3D are diagrams for describing a configuration example of each unit in FIG. 1.

### <Cabin Environment Control Apparatus>

FIG. 3A is a block diagram illustrating a configuration of a main part of the control apparatus 20. The control apparatus 20 includes an arithmetic processing unit such as a micro processing unit (MPU) (not illustrated) and reads and executes a predetermined program stored in a storage unit (not illustrated) to perform various types of information processing, control processing, and the like necessary for the control apparatus 20.

The control apparatus 20 includes, as a functional configuration for a cabin environment control apparatus 230, an occupant information acquisition unit 231, a reverberation effect addition unit 232, a voice acquisition unit 233, a seating environment information acquisition unit 234, a lighting control unit 235, an illumination control unit 236, a content acquisition unit 205, a reproduction unit 206, and a communication unit 209, and performs control such that the IVI system functions as the cabin environment control apparatus 230.

### (Occupant Information Acquisition Unit)

The occupant information acquisition unit 231 estimates (calculates) the degrees of fatigue of the occupants P1 and P2 in the cabin by using predetermined learning processing based on pieces of biological information of the occupants P1 and P2 acquired by the terminals 2A and 2B. Here, for example, an algorithm such as support vector machines (SVM) in machine learning may be used for the learning processing.

Furthermore, the occupant information acquisition unit 231 may estimate the degrees of fatigue of the occupants P1 and P2 from, for example, the number of yawns, the number of blinks, a change in posture from the beginning of boarding, and the like per predetermined time based on image information from the vehicle cabin camera 13 (the front seat camera 131 and the rear seat camera 132).

### (Reverberation Effect Addition Unit)

When the degrees of fatigue of the occupants P1 and P2 acquired by the occupant information acquisition unit 231 are equal to or higher than a predetermined value, the control apparatus 20 functioning as the reverberation effect addition unit 232 controls the reproduction unit 206 to add the reverberation effect to the sound content and reproduce the sound content. As a result, when the degrees of fatigue of the occupants P1 and P2 increase, the reproduction unit 206 outputs, to the output device 50 (the voice reproducing units 53A to 53D), a reproduction signal for the sound content to which the reverberation effect is added.

The control apparatus 20 is configured to be able to set an intensity of the reverberation effect (which may be referred to as an increase or decrease in addition amount) added to the sound content and a volume for each of the seating positions where the occupants P1 and P2 in the cabin are seated, according to a difference in the degree of fatigue between the occupants P1 and P2. For example, the control apparatus 20 may control the reproduction unit 206 such that the higher the degree of fatigue, the stronger the reverberation effect added to the sound content. Furthermore, for example, the control apparatus 20 may control the reproduction unit 206 to increase a reproduction volume of the sound content as the degree of fatigue is higher.

In addition, the control apparatus 20 is configured to be able to set the intensity of the reverberation effect added to the sound content for each seating position based on brightness information for each of the seating positions of the occupants P1 and P2 acquired by the seating environment information acquisition unit 234. For example, the control apparatus 20 may control the reproduction unit 206 such that the lower the brightness of the seating position, the stronger the reverberation effect added to the sound content.

Furthermore, for a driver's seat, the control apparatus 20 may control the reproduction unit 206 so as not to add the reverberation effect to the sound content.

### (Voice Acquisition Unit)

The voice acquisition unit 233 acquires voices uttered by the occupants P1 and P2 as the voice contents. More specifically, the voice acquisition unit 233 acquires, as the voice contents, voice signals input from the microphones 111A and 111B included in the input device 11.

### (Seating Environment Information Acquisition Unit)

The seating environment information acquisition unit 234 acquires the brightness information for each of the seating positions where the occupants P1 and P2 in the cabin are seated. Specifically, the seating environment information acquisition unit 234 detects the brightness at each of the seating position of the occupant P1 and the seating position of the occupant P2 based on a camera image from each of the front seat camera 131 and the rear seat camera 132, and acquires the brightness information including a detection result. The brightness at each of the seating positions of the occupants P1 and P2 may be detected by another sensor such as an optical sensor or an illuminance sensor.

### (Lighting Control Unit)

The lighting control unit 235 controls a lighting amount of the lighting device 70 for each seating position in order to adjust the brightness for each of the seating positions of the occupants P1 and P2. The lighting control unit 235 may control the lighting device 70 such that the lighting amount for each seating position fluctuates according to the addition amount of the reverberation effect for each seating position added to the sound content by the reproduction unit 206.

### (Illumination Control Unit)

The illumination control unit 236 controls illumination light of an ambient light 60A and an ambient light 60B for each seating position in order to adjust the brightness for each of the seating positions of the occupants P1 and P2. The illumination control unit 236 may control the illumination device 60 such that the illumination light for each seating position fluctuates according to the addition amount of the reverberation effect for each seating position added to the sound content by the reproduction unit 206.

### (Content Acquisition Unit)

In a case where it is determined that content reproduction for soothing the occupants P1 and P2 by the reverberation effect is necessary, the content acquisition unit 205 acquires a content from the terminals 2A and 2B possessed by the plurality of occupants P1 and P2 in the cabin via the communication unit 209. The content acquisition unit 205 may acquire the content not only from the terminals 2A and 2B but also from an external content management server via a communication network (not illustrated). The content management server includes a cloud storage that stores a content and a streaming server that reproduces a content. The content acquisition unit 205 searches for and acquires a content to be reproduced for soothing by using a predetermined search formula. The content acquisition unit 205 may acquire the sound content (for example, contents prepared in advance by the occupants P1 and P2 to listen to at the time of feeling fatigue) stored in the content storage unit 23 of each of the terminals 2A and 2B.

The acquired content may be a video content (a moving image, a still image, or the like) including a voice or a content including only a voice. In the embodiment, the reverberation effect can be added to sound included in the video content similarly to the sound content.

### (Reproduction Unit)

In a case where the content to be reproduced is the video content, the reproduction unit 206 outputs a video signal to the output device 50.

Furthermore, in a case where the content to be reproduced is the sound content, the reproduction unit 206 outputs the reproduction signal to the output device 50.

### (Communication Unit)

The communication unit 209 includes a short-range wireless communication module (not illustrated) that performs wireless communication with the terminals 2A and 2B and a wired communication module (not illustrated) that performs wired communication by the CAN or the like. A wireless communication system having a direction sensing function may be adopted as the short-range wireless communication module.

### <Terminal>

FIG. 3B is a block diagram illustrating a configuration of a main part of the terminal 2A. Since a configuration of the terminal 2B is similar to that of the terminal 2A, illustration thereof is omitted. The terminal 2A includes an arithmetic processing unit such as an MPU (not illustrated), and reads and executes a predetermined program (which may also be referred to as an application) stored in a storage unit (not illustrated) to perform various types of information processing, control processing, and the like necessary for a functional configuration described below.

The terminal 2A includes, as the functional configuration, a personal information storage unit 21, a relationship information storage unit 22, a content storage unit 23, a biometric sensor group 24, and a communication unit 25. In general, a smartphone includes a display unit, an input unit, a voice reproducing unit, a camera, a position detection unit, and the like, but illustration and description thereof are omitted.

The terminal 2A may share a function with another device such as a smart watch (not illustrated).

### (Personal Information Storage Unit)

The personal information storage unit 21 stores personal information of the occupant P1 who possesses the terminal 2A. In a case where the IVI system functions as the cabin environment control apparatus 230, the personal information is not necessary.

### (Relationship Information Storage Unit)

The relationship information storage unit 22 stores relationship level information of the occupant P1 using the terminal 2A. In a case where the relationship level information indicating the degree of intimacy between the occupants P1 and P2 in the cabin is transmitted from the control apparatus 20, the relationship information storage unit 22 stores the relationship level information. In a case where the IVI system functions as the cabin environment control apparatus 230, the relationship level information is not necessary.

### (Content Storage Unit)

The content storage unit 23 stores a content collected by the occupant P1 who possesses the terminal 2A or information (for example, a cloud storage that stores a content or a URL of a server that streams and reproduces a content) necessary for reproducing a content. In a case where the IVI system functions as the cabin environment control apparatus 230, the sound content that the occupant P1 wants to listen to at the time of feeling fatigue may be stored in the content storage unit 23 in advance.

### (Biometric Sensor Group)

The biometric sensor group 24 includes, for example, a heart rate sensor that acquires a heart rate of the occupant P1 who possesses the terminal 2A, a respiration sensor that acquires a respiration rate, a blood flow rate sensor that acquires a blood flow rate, and a skin electrical resistance sensor that acquires a skin electrical resistance value (all the sensors described above are not illustrated). In a case where the IVI system functions as the cabin environment control apparatus 230, the biological information of the occupant P1 collected by the biometric sensor group 24 is used when the occupant information acquisition unit 231 estimates the degree of fatigue of the occupant P1.

### (Communication Unit)

The communication unit 25 includes a short-range wireless communication module (not illustrated) that performs wireless communication with the control apparatus 20 and a wired communication module (not illustrated) that performs wired communication by the CAN or the like.

FIG. 3C is a block diagram illustrating configurations of main parts of the vehicle sensor group 12 and the vehicle cabin camera 13 of the vehicle 100.

### <Vehicle Sensor Group>

The vehicle sensor group 12 includes a vehicle speed sensor 121, a position measuring sensor 122, and a camera 123. In general, an acceleration sensor, a radar, and the like are mounted as sensors on the vehicle 100, but illustration and description thereof are omitted.

### (Vehicle Speed Sensor)

The vehicle speed sensor 121 detects a vehicle speed of the vehicle 100 and outputs vehicle speed information to the control apparatus 20. In a case where the IVI system functions as the cabin environment control apparatus 230, the vehicle speed information is not necessary.

### (Position Measuring Sensor)

The position measuring sensor 122 detects a current position of the vehicle 100 based on a positioning signal from a global positioning system (GPS) satellite, a quasi-zenith satellite, or the like. The position measuring sensor 122 outputs a signal indicating the current position to the control apparatus 20 as position information. In a case where the IVI system functions as the cabin environment control apparatus 230, information regarding the current position is not necessary.

### (Camera)

The camera 123 images the surroundings of the vehicle 100. The camera 123 outputs data of a subject image to the control apparatus 20 as image information. The camera 123 can capture still images and videos. In a case where the IVI system functions as the cabin environment control apparatus 230, the image information of the surroundings of the vehicle 100 is not necessary.

### <Vehicle Cabin Camera>

The vehicle cabin camera 13 includes the front seat camera 131 and the rear seat camera 132. The front seat camera 131 images the upper body of the occupant P1 seated in the front seat, and outputs data of the subject image to the control apparatus 20 as the image information. The rear seat camera 132 images the upper body of the occupant P2 seated in the rear seat, and outputs data of the subject image to the control apparatus 20 as the image information.

FIG. 3D is a block diagram illustrating configurations of main parts of the input device 11 and the output device 50 of the vehicle 100.

### <Input Device>

The input device 11 includes the operation detection units 11A and 11B and the microphones 111A and 111B.

### (Operation Detection Unit)

The operation detection unit 11A is operated by the occupant P1 in the front seat, and outputs an operation signal to the control apparatus 20. The operation detection unit 11A may be implemented as a pointing device that is operated in conjunction with the projected image projected by the projection unit 52 described below. The operation detection unit 11B is provided on a display surface of the display unit 51. The operation detection unit 11B is operated by the occupant P2 in the rear seat and outputs an operation signal indicating a touch position to the control apparatus 20.

### (Microphone)

The microphone 111A collects the voice uttered by the occupant P1 in the front seat and outputs the voice signal to the control apparatus 20. The microphone 111B collects the voice uttered by the occupant P2 in the rear seat and outputs the voice signal to the control apparatus 20.

### <Output Device>

The output device 50 includes the display unit 51, the projection unit 52, and the voice reproducing units 53. The output device 50 is used, for example, for displaying the operation menu screen of FIG. 2, reproducing a content, or the like. (Display Unit)

The display unit 51 includes a screen such as a liquid crystal display, and displays the image information based on a display signal output from the control apparatus 20. The image information includes the operation menu screen of FIG. 2, the image of the video content, and the like.

### (Projection Unit)

The projection unit 52 is implemented by, for example, a head-up display (HUD) to be projected on a windshield or the like, and projects the image information based on a projection signal output from the control apparatus 20. The image information includes the operation menu screen of FIG. 2, the image of the video content, and the like.

### (Voice Reproducing Unit)

The voice reproducing units 53A to 53D are implemented as speakers (sound output devices) that reproduce and output the voice and the like, and reproduce the sound content based on the reproduction signal output from the control apparatus 20. Note that a sound output unit that outputs a content reproduction signal to a headphone (not illustrated) or the like may be provided.

### <Description of Flowchart>

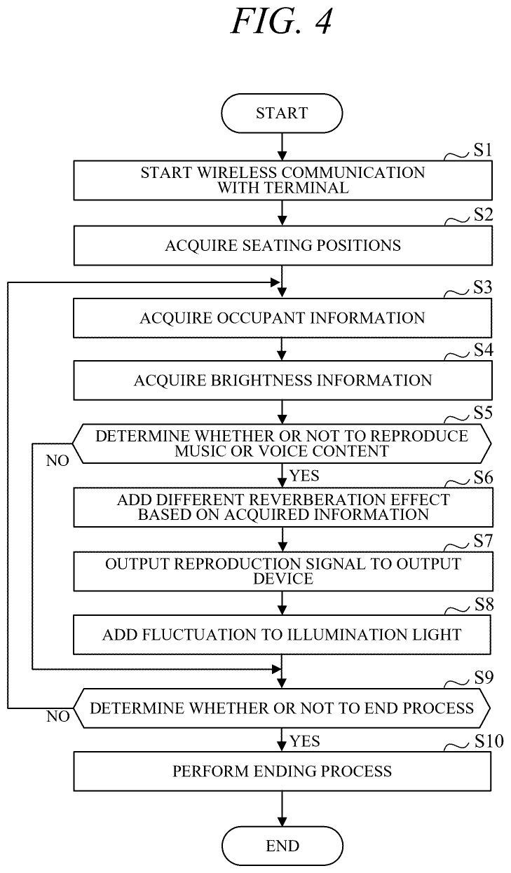

FIG. 4 is a flowchart for describing an example of cabin environment control processing by the program executed by the MPU of the control apparatus 20. When the “soothing sounds” button is operated on the operation menu screen of FIG. 2, the MPU of the control apparatus 20 executes a program for performing the processing illustrated in FIG. 4 in order to cause the IVI system to function as the cabin environment control apparatus 230. The control apparatus 20 functions as a control unit of the cabin environment control apparatus 230 during execution of the program.

In step S1 of FIG. 4, the control apparatus 20 causes the communication unit 209 to start wireless communication with the terminals 2A and 2B possessed by the occupants P1 and P2 in the cabin, and proceeds to step S2. In a case where the communication unit 209 and the terminals 2A and 2B have already started the wireless communication, the control apparatus 20 directly proceeds to step S2.

In step S2, the control apparatus 20 acquires the seating positions where the occupants P1 and P2 in the cabin are seated based on the image information from the vehicle cabin camera 13 (the front seat camera 131 and the rear seat camera 132), and proceeds to step S3.

The control apparatus 20 may acquire the seating positions of the occupants P1 and P2 based on the voices collected by the microphone 111A and the microphone 111B included in the input device 11. The voice signal from the microphone 111A corresponds to the voice of the occupant P1 in the front seat, and the voice signal from the microphone 111B corresponds to the voice of the occupant P2 in the rear seat.

In step S3, the control apparatus 20 causes the occupant information acquisition unit 231 to acquire occupant information. More specifically, the occupant information acquisition unit 231 estimates the degree of fatigue of each of the occupants P1 and P2 based on the biological information of each of the occupants P1 and P2 whose seating positions have been acquired, and the control apparatus 20 proceeds to step S4.

In step S4, the control apparatus 20 causes the seating environment information acquisition unit 234 to acquire the brightness information of the seating position, and proceeds to step S5. More specifically, the seating environment information acquisition unit 234 acquires the brightness information for each of the seating positions of the occupants P1 and P2, and transmits the acquired brightness information to the control apparatus 20.

In step S5, the control apparatus 20 determines whether or not to reproduce a music or a voice. In a case where reproduction of the music content or the voice content is permitted, the control apparatus 20 makes an affirmative determination in step S5 and proceeds to step S6. In a case where the reproduction of the sound content is not permitted, the control apparatus 20 makes a negative determination in step S5 and proceeds to step S9. For example, in a case where a mute switch is operated, the control apparatus 20 determines that the reproduction of the sound content is not permitted.

In step S6, the control apparatus 20 functioning as the reverberation effect addition unit 232 described above controls the reproduction unit 206 to add a different reverberation effect to the sound content based on the acquired information acquired by the occupant information acquisition unit 231, and proceeds to step S7. More specifically, when the degree of fatigue of each of the occupants P1 and P2 is equal to or higher than a predetermined value, the control apparatus 20 adds a different reverberation effect to the reproduction signal for the sound content to be output to the output device 50 (voice reproducing units 53A to 53D) corresponding to each of the occupants P1 and P2 according to the degree of fatigue of each of the occupants P1 and P2.

In addition, the control apparatus 20 may add a different reverberation effect to the reproduction signal for the sound content to be output to the output device 50 (voice reproducing units 53A to 53D) corresponding to each of the occupants P1 and P2 according to the brightness for each seating position acquired by the seating environment information acquisition unit 234.

In step S7, the control apparatus 20 causes the reproduction unit 206 to output the reproduction signal for the sound content to which the reverberation effect has been added in step S6 to the output device 50 (voice reproducing units 53A to 53D), and proceeds to step S8.

In step S8, the control apparatus 20 causes the illumination control unit 236 to add fluctuation to the illumination light for each seating position, and proceeds to step S9. More specifically, the illumination control unit 236 controls the illumination device 60 such that the illumination light for each seating position fluctuates according to the addition amount of the reverberation effect for each seating position added to the reproduction signal by the reproduction unit 206.

The control apparatus 20 may cause the lighting control unit 235 to add fluctuation to the lighting amount of the lighting device 70 for each seating position. More specifically, the lighting control unit 235 controls the lighting device 70 such that the lighting amount of the lighting device 70 for each seating position fluctuates according to the addition amount of the reverberation effect for each seating position added to the reproduction signal by the reproduction unit 206.

In step S9, the control apparatus 20 determines whether or not to end the cabin environment control processing. In a case where a predetermined end operation is performed, the control apparatus 20 makes an affirmative determination in step S9 and proceeds to step S10, and in a case where the end operation is not performed, the control apparatus 20 makes a negative determination in step S9 and returns to step S3. In the case of returning to step S3, the control apparatus 20 repeats the above-described processing. That is, the reverberation effect is added to the sound content to be reproduced toward the occupants P1 and P2 according to the degrees of fatigue of the occupants P1 and P2, thereby soothing the occupants P1 and P2.

In step S10, the control apparatus 20 performs end processing and ends the processing of FIG. 4. The end processing includes, as an example, the end of the outputting of the sound content by the reproduction unit 206 and the end of the wireless communication with the terminals 2A and 2B by the communication unit 209. The wireless communication between the communication unit 209 and the terminals 2A and 2B does not have to end in a case where the wireless communication is required in processing other than the cabin environment control processing.

According to the embodiment described above, the following effects are obtained.

(1) The cabin environment control apparatus 230 of the vehicle 100 includes: the occupant information acquisition unit 231 that acquires fatigue degree information indicating the degrees of fatigue of the occupants P1 and P2 of the vehicle 100 based on the pieces of biological information of the occupants P1 and P2; the reproduction unit 206 that reproduces the sound content in the cabin; and the reverberation effect addition unit 232 serving as a control unit that controls the reproduction unit 206 to add the reverberation effect to the sound content and reproduce the sound content when the degrees of fatigue of the occupants P1 and P2 acquired by the occupant information acquisition unit 231 are equal to or higher than a predetermined value.

With such a configuration, it is possible to reduce mental fatigue by soothing the fatigued occupants P1 and P2 with sound. For example, by simulatively producing the reverberation effect of a wide acoustic space, the occupants P1 and P2 can recall a calm space such as a temple or a church, so that fatigue can be reduced.

(2) The cabin environment control apparatus 230 further includes the voice acquisition unit 233 that acquires the voices uttered by the occupants P1 and P2 as the sound content, and the reverberation effect addition unit 232 controls the reproduction unit 206 to add the reverberation effect to the voices of the occupants P1 and P2 and reproduce the voices.

With such a configuration, it is possible to reduce the mental fatigue of the occupants P1 and P2 by adding the reverberation effect to the voices uttered by the occupants P1 and P2.

(3) The cabin environment control apparatus 230 further includes the content acquisition unit 205 serving as a music content acquisition unit that acquires the music content as the sound content, and the reverberation effect addition unit 232 controls the reproduction unit 206 to add the reverberation effect to the music content and reproduce the music content.

With such a configuration, it is possible to reduce the mental fatigue of the occupants P1 and P2 by adding the reverberation effect to the music content acquired by the content acquisition unit 205.

(4) In the cabin environment control apparatus 230, the occupant information acquisition unit 231 acquires the fatigue degree information for each of the occupants P1 and P2, and the reverberation effect addition unit 232 controls a reproduction volume of the sound content in the reproduction unit 206 and the addition amount of the reverberation effect for each of the occupants P1 and P2.

With such a configuration, it is possible to reduce the mental fatigue of each person according to the degree of fatigue of each of the occupants P1 and P2.

(5) The cabin environment control apparatus 230 further includes the seating environment information acquisition unit 234 that acquires the brightness information of the seating position of each of the occupants P1 and P2, and the reverberation effect addition unit 232 controls the reproduction unit 206 to increase the addition amount of the reverberation effect for the sound content as the brightness of the seating position becomes lower.

With such a configuration, by adding a greater reverberation effect as the brightness of the seating position is lower, it is possible to further reduce the mental fatigue as compared with a case where the brightness of the seating position is not considered.

(6) The cabin environment control apparatus 230 further includes the illumination device 60 serving as an illumination unit that illuminates the seating position of each of the occupants P1 and P2, and the reverberation effect addition unit 232 (control apparatus 20) controls the illumination device 60 such that the illumination light for each seating position fluctuates according to the addition amount of the reverberation effect for each seating position in the reproduction unit 206.

With such a configuration, the illumination light for each seating position fluctuates according to the addition amount of the reverberation effect for each seating position, so that it is possible to further reduce the mental fatigue as compared with a case where there is no fluctuation in the illumination light.

(7) In the cabin environment control apparatus 230, the reverberation effect addition unit 232 controls the reproduction of the sound content for each of the occupants P1 and P2 in the reproduction unit 206, and controls the reproduction unit 206 to reproduce the sound content to which the reverberation effect is added at the seating position excluding the driver's seat of the vehicle 100.

With such a configuration, it is possible to reduce the mental fatigue by soothing the occupant P2 seated in the seating position excluding the driver's seat with sound in consideration of a possibility that there is a driver who feels the reverberation effect as an obstacle to driving.

The above embodiment can be modified in various manners. Hereinafter, modified examples will be described.

### First Modified Example

In the above embodiment, an example in which four persons including the driver are in the cabin has been described, but the number of occupants is not limited to four, and may be six or 10.

### Second Modified Example

In the embodiment and the first modified example described above, the vehicle 100 serving as the moving body has been exemplified as an example of the cabin in which a content is reproduced. However, a cabin of a moving body on which a plurality of occupants board may be treated similarly to the cabin described above.

The above embodiment can be combined as desired with one or more of the above modifications. The modifications can also be combined with one another.

According to the present invention, it is possible to reduce mental fatigue of an occupant.

Above, while the present invention has been described with reference to the preferred embodiments thereof, it will be understood, by those skilled in the art, that various changes and modifications may be made thereto without departing from the scope of the appended claims.

What is claimed is:

1. A cabin environment control apparatus comprising
a microprocessor connected to a sound output device provided in a cabin of a vehicle, wherein
the microprocessor is configured to perform:
calculating a degree of fatigue of an occupant of the vehicle based on biological information of the occupant;
generating a signal for reproducing sound content to the sound output device; and
controlling the sound output device to add a reverberation effect to the sound content and reproduce the sound content when the degree of fatigue of the occupant is equal to or higher than a predetermined value.

2. The cabin environment control apparatus according to claim 1, wherein
the microprocessor is configured to further perform acquiring a voice uttered by the occupant as the sound content, and
the microprocessor is configured to perform
the controlling including controlling the sound output device to add the reverberation effect to the voice of the occupant and reproduce the voice.

3. The cabin environment control apparatus according to claim 1, wherein
the microprocessor is configured to further perform acquiring music content as the sound content, and
the microprocessor is configured to perform
the controlling including controlling the sound output device to add the reverberation effect to the music content and reproduce the music content.

4. The cabin environment control apparatus according to claim 1, wherein
the microprocessor is configured to perform:
the calculating including calculating the degree of fatigue for occupants in the cabin individually; and
the controlling including controlling a reproduction volume of the sound content and an addition amount of the reverberation effect for each of the occupants.

5. The cabin environment control apparatus according to claim 4, wherein
the microprocessor is further connected to a sensor configured to detect brightness in the cabin,
the microprocessor is configured to further perform
acquiring the brightness of a seating position of each of the occupants based on detection data of the sensor, and
the microprocessor is configured to perform
the controlling including controlling the sound output device to increase the addition amount of the reverberation effect for the sound content as the brightness of the seating position becomes lower.

6. The cabin environment control apparatus according to claim 5, wherein
the microprocessor is further connected to an illumination device configured to illuminate the seating position of each of the occupants,
the microprocessor is configured to perform
the controlling including controlling the illumination device such that illumination light for each seating position fluctuates according to the addition amount of the reverberation effect for each seating position.

7. The cabin environment control apparatus according to claim 1, wherein
the microprocessor is configured to perform
the controlling including controlling reproduction of the sound content by the sound output device, for each of the occupants, and controlling the sound output device to reproduce the sound content to which the reverberation effect is added at a seating position excluding a driver's seat of the vehicle.

8. The cabin environment control apparatus according to claim 1, wherein
the microprocessor includes a communication module capable of wireless communication with a terminal carried by the occupant,
the microprocessor is configured to further perform acquiring the biological information of the occupant from the terminal via the communication module,
the biological information includes detection data of a biosensor included in the terminal, and
the microprocessor is configured to perform the calculating including calculating the degree of fatigue of the occupant based on the biological information, using machine learning.
